(19) United States
(12) Patent Application Publication
(10) Pub. No.: US 2022/0322413 A1
(43) Pub. Date: Oct. 6, 2022

(54) Method and Apparatus for Multiple Transmission Points

(71) Applicant: MediaTek Singapore Pte. Ltd., Singapore (SG)

(72) Inventor: Gyu Bum Kyung, San Jose, CA (US)

(21) Appl. No.: 17/685,289

(22) Filed: Mar. 2, 2022

Related U.S. Application Data
(60) Provisional application No. 63/171,118, filed on Apr. 6, 2021.

(51) Int. Cl. H04W 72/12

(52) U.S. Cl. CPC H04W 72/1289

(57) ABSTRACT

A method of Transmission Configuration Indication (TCI) state mapping and (Quasi Co Location) (QCL) assumption for PDSCH transmission and reception under multiple transmission point (M-TRP) scheme with PDCCH repetition scheduling is proposed. New rules of TCI state mapping and QCL assumption are defined for PDSCH when there are two CORESETS with two corresponding TCI states under M-TRP scheme with PDCCH repetition scheduling. For M-TRP PDCCH scheduling S-TRP PDSCH, the TCI state of a CORESET with a lower ID is used as the TCI state. For M-TRP PDCCH scheduling M-TRP PDSCH, different TCI state mapping rules are defined, depending on the PDSCH transmission occasions are transmitted in CDM, FDM, or TDM.

### CROSS REFERENCE TO RELATED APPLICATIONS

This application claims priority under 35 U.S.C. § 119 from U.S. Provisional Application No. 63/171,118, entitled “Method and Apparatus for Multiple Transmission Points,” filed on Apr. 6, 2021, the subject matter of which is incorporated herein by reference.

### TECHNICAL FIELD

The disclosed embodiments relate generally to wireless communication, and, more particularly, to PDCCH and PDSCH transmission involving multiple transmission points (TRPs) in new radio (NR) mobile communication networks.

### BACKGROUND

The fifth generation (5G) radio access technology (RAT) will be a key component of the modern access network. It will address high traffic growth and increasing demand for high-bandwidth connectivity. It will address high traffic growth, energy efficiency and increasing demand for high-bandwidth connectivity. It will also support massive numbers of connected devices and meet the real-time, high-reliability communication needs of mission-critical applications. In the legacy wireless communication, a user equipment (UE) is normally connected to a single serving base station and communicates with the serving base station for control and data transmission. The 5G network is designed with dense base station deployment and heterogeneous system design are deployed. Multiple-connection technologies, such as coordinated multipoint (CoMP) transmission, is expected to get more widely deployment to get higher data rate and higher spectral efficiency gains. The multiple-connection model for the wireless communicate requires UEs to coordinate with multiple transmission points (M-TRPS) for reporting and control information reception.

In Rel-16, single downlink control information (DCI) based M-TRP scheme was introduced for ultra-reliable low-latency communications (URLLC) scheme. Two Physical Downlink Shared Channel (PDSCH) transmission occasions conveying the same transport block (TB) are transmitted from two TRPS to increase the reliability of downlink data. Resource allocation for two PDSCH transmission occasions can be done by single DCI from one TRP. For example, each PDSCH transmission occasion corresponds to the same or different redundancy versions (RVs) of the same TB. Each PDSCH transmission occasion can be transmitted in frequency division multiplexing (FDM), spatial division multiplexing (SDM), and time division multiplexing (TDM).

However, the reliability for Physical Downlink Control Channel (PDCCH) should be enhanced to fully use the benefit of multi-TRP based URLLC scheme in Rel-16 because the channel from the TRP sending PDCCH can be blocked. Multiple PDCCH transmissions from M-TRPS using different beams indicating the same allocation information for PDSCH transmission occasions can improve the reliability of PDCCH. These PDCCHs can convey the same DCI or different DCI, but indicate the same resource allocation.

Two antenna ports are said to be quasi-co-located if properties of the channel over which a symbol on one antenna port is conveyed can be inferred from the channel over which a symbol on the other antenna port is conveyed. Transmission Configuration Indicator (TCI) states are dynamically sent over in DCI, which includes configuration such as QCL (Quasi Co Location) information for PDSCH. UE can be configured with a list of TCI-State configurations within the higher layer parameter PDSCH-Config to decode PDSCH according to a detected PDCCH with DCI intended for the UE and the given serving cell. Each TCI-State contains parameters for configuring a quasi-co-location relationship between one or two downlink reference signals and the DM-RS ports of the PDSCH.

Traditionally, QCL of PDSCH can be configured to follow a TCI field in downlink DCI. Under M-TRP PDCCH repetition schedule, two control resource sets (CORSETS) associated with two search space sets including two PDCCH candidates are used. New rules of TCI state mapping for PDSCH need to be defined when there are two CORESETS with two corresponding TCI states.

### SUMMARY

A method of Transmission Configuration Indication (TCI) state mapping and (Quasi Co Location) (QCL) assumption for PDSCH transmission and reception under multiple transmission point (M-TRP) scheme with PDCCH repetition scheduling is proposed. New rules of TCI state mapping and QCL assumption are defined for PDSCH when there are two CORESETS with two corresponding TCI states under M-TRP scheme with PDCCH repetition scheduling. For M-TRP PDCCH scheduling Single transmission point (S-TRP) PDSCH, the TCI state of a CORESET with a lower ID is used as the TCI state. For M-TRP PDCCH scheduling M-TRP PDSCH, different TCI state mapping rules are defined, depending on the PDSCH transmission occasions are transmitted in CDM, FDM, or TDM.

In one embodiment, a UE receives a first downlink control information (DCI) over a first physical downlink control channel (PDCCH) from a first transmission point (TRP) in a beamforming communication network. The UE is configured to operate under multiple transmission points (TRPs). The first DCI schedules a first physical downlink shared channel (PDSCH) transmission occasion. The UE receives a second DCI over a second PDCCH from a second TRP. The second DCI schedules a second PDSCH transmission occasion. The UE decodes the first DCI and the second DCI. The first and the second DCI does not carry any transmission configuration indicator (TCI) for the PDSCH transmission occasions. The UE determines TCI states for the PDSCH transmission occasions based at least on one of a) TCI states of corresponding to control resource set (CORESET) of the first and the second PDCCHs and b) a corresponding multiplexing scheme applied on the first and the second PDSCH transmission occasions. The UE receives the first and the second PDSCH transmission occasions using the determined TCI states.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a new radio (NR) beamforming wireless communication system supporting multiple transmission points (M-TRP) physical downlink control channel (PDCCH) repetition scheduling and transmission configuration indication (TCI) state determination in accordance with one novel aspect.

FIG. 2 is a simplified block diagram of a base station and a user equipment that carry out certain embodiments of the present invention.

FIG. 3 illustrates PDCCH scheduling offset and corresponding TCI state determination or QCL assumption for PDSCH transmission and reception.

FIG. 4 illustrates a first embodiment of TCI state determination or QCL assumption under M-TRP PDCCH scheduling for S-TRP PDSCH.

FIG. 5 illustrates a second embodiment of TCI state determination or QCL assumption under M-TRP PDCCH scheduling for M-TRP PDSCH in SDM.

FIG. 6 illustrates a third embodiment of TCI state determination or QCL assumption under M-TRP PDCCH scheduling for M-TRP PDSCH in FDM.

FIG. 7A illustrates a fourth embodiment of TCI state determination or QCL assumption under M-TRP PDCCH scheduling for M-TRP PDSCH in TDM in the same slot,

FIG. 7B illustrates a fourth embodiment of TCI state determination or QCL assumption under M-TRP PDCCH scheduling for M-TRP PDSCH across slots.

FIG. 8 is a message sequence flow between a UE and two TRPs for M-TRP PDCCH scheduling and corresponding TCI state mapping for PDSCH.

FIG. 9 is a flow chart of a method of TCI state mapping for PDSCH under M-TRP scheme with PDCCH repetition scheduling in accordance with one novel aspect.

### DETAILED DESCRIPTION

Reference will now be made in detail to some embodiments of the invention, examples of which are illustrated in the accompanying drawings.

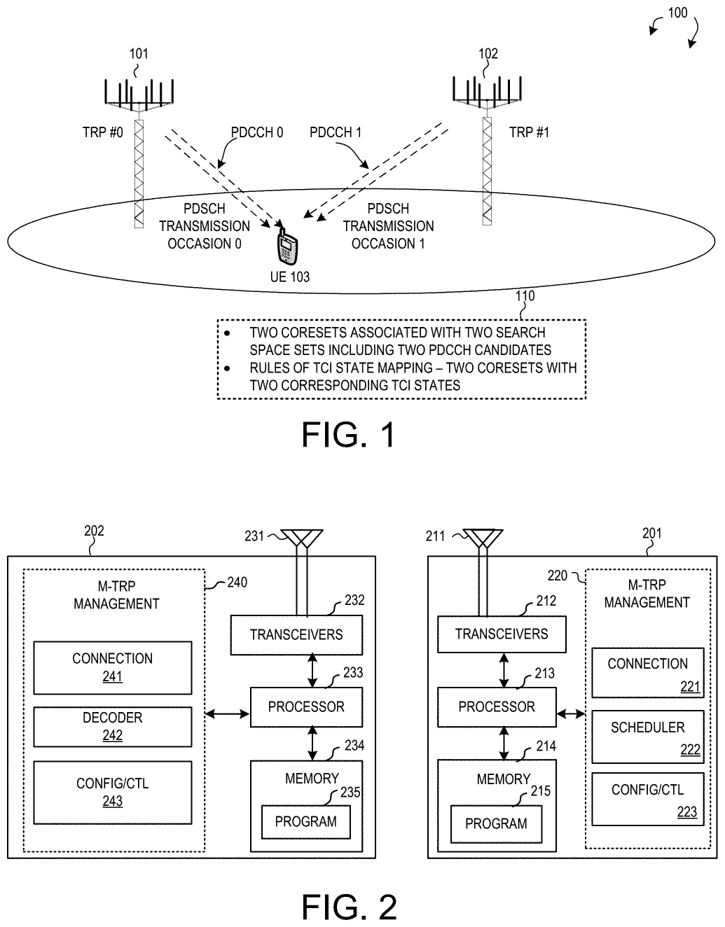

FIG. 1 illustrates a new radio (NR) beamforming wireless communication system supporting multiple transmission points (M-TRP) physical downlink control channel (PDCCH) repetition scheduling and transmission configuration indication (TCI) state determination in accordance with one novel aspect. NR beamforming wireless communication network 100 comprises a first base station BS or a TRP 101, a second BS or a TRP 102, and a user equipment UE 103. In next 5G NR systems, a base station (BS) is referred to as a gNodeB or gNB. The base station performs beamforming in NR, e.g., in both FR1 (sub-6 GHz spectrum) or FR2 (Millimeter Wave frequency spectrum). The NR cellular network uses directional communications with beamformed transmission and can support up to multi-gigabit data rate. Directional communications are achieved via digital/analog beamforming, where multiple antenna elements are applied with multiple sets of beamforming weights to form multiple beams.

When there is a downlink packet to be sent from the BS to the UE, each UE gets a downlink assignment, e.g., a set of radio resources in a physical downlink shared channel (PDSCH). When a UE needs to send a packet to the BS in the uplink, the UE gets a grant from the BS that assigns a physical uplink shared channel (PUSCH) consisting of a set of uplink radio resources. The UE gets the downlink or uplink scheduling information from a PDCCH that is targeted specifically to that UE. In addition, broadcast control information is also sent in the PDCCH to all UEs in a cell. The downlink and uplink scheduling information and the broadcast control information, carried by the PDCCH, together is referred to as downlink control information (DCI).

In NR, beamforming-based directional links require fine alignment of the transmitter and receiver beams, achieved through a set of operations known as beam management. One mode of operation is beam management with indication, where quasi-co-location (QCL) is used to provide an instruction to the UE which it can use to adjust received settings. Two antenna ports are said to be quasi-co-located if properties of the channel over which a symbol on one antenna port is conveyed can be inferred from the channel over which a symbol on the other antenna port is conveyed. Transmission Configuration Indicator (TCI) states are dynamically sent over in DCI, which includes configuration such as QCL information for PDSCH. UE can be configured with a list of TCI-State configurations within the higher layer parameter PDSCH-Config to decode PDSCH according to a detected PDCCH with DCI intended for the UE and the given serving cell. Each TCI-State contains parameters for configuring a quasi-co-location relationship between downlink reference signals and the DM-RS ports of the PDSCH.

Traditionally, QCL of PDSCH can be configured to follow a TCI field in a downlink DCI carried by the corresponding PDCCH. However, under M-TRP PDCCH repetition schedule, two control resource sets (CORSETS) associated with two search space sets including two PDCCH candidates are used. In accordance with one novel aspect, new rules of TCI state mapping and QCL assumption are defined for PDSCH when there are two CORESETS with two corresponding TCI states under M-TRP scheme with PDCCH repetition scheduling (110). In the example of FIG. 1, UE 103 receives PDCCH repetition scheduling under M-TRP scheme, e.g., PDCCH 0 from TRP #0 for scheduling PDSCH transmission occasion 0, and PDCCH 1 from TRP #1 for scheduling PDSCH transmission occasion 1. PDCCH 0 and PDCCH 1 using different beams indicating the same allocation information for PDSCH transmission occasions can improve the reliability of PDCCH. For M-TRP PDCCH scheduling S-TRP PDSCH, the TCI state of a CORESET with a lower ID is used as the TCI state. For M-TRP PDCCH scheduling M-TRP PDSCH, different TCI state mapping rules are defined, depending on the PDSCH transmission occasions are transmitted in CDM, FDM, or TDM.

FIG. 2 is a simplified block diagram of a base station 201 and a user equipment 202 that carry out certain embodiments of this present invention. BS 201 has an antenna array 211 having multiple antenna elements that transmits and receives radio signals, one or more RF transceiver modules 212, coupled with the antenna array, receives RF signals from antenna 211, converts them to baseband signal, and sends them to processor 213. RF transceiver 212 also converts received baseband signals from processor 213, converts them to RF signals, and sends out to antenna 211. Processor 213 processes the received baseband signals and invokes different functional modules to perform features in BS 201. Memory 214 stores program instructions and data 215 to control the operations of BS 201. BS 201 also includes multiple function modules and circuits 220 that carry out different tasks in accordance with embodiments of the current invention.

Similarly, UE 202 has an antenna array 231, which transmits and receives radio signals. RF transceivers module 232, coupled with the antenna array, receives RF signals from antenna array 231, converts them to baseband signals and sends them to processor 233. RF transceivers 232 also converts received baseband signals from processor 233, converts them to RF signals, and sends out to antenna array 231. Processor 233 processes the received baseband signals and invokes different functional modules to perform features in UE 202. Memory 234 stores program instructions and data 235 to control the operations of UE 202. UE 202 also includes multiple function modules and circuits 240 that carry out different tasks in accordance with embodiments of the current invention.

The functional modules and circuits can be implemented and configured by hardware, firmware, software, and any combination thereof. In one example, for UE 202, connection handling circuit 241 handles the establishment and management of connections with the network, decoder 242 decodes received information such as DCI from PDCCH scheduling from M-TRP, configuration and control circuit 243 handles configuration and control parameters from the network, such as determining TCI state information for PDSCH transmission occasions.

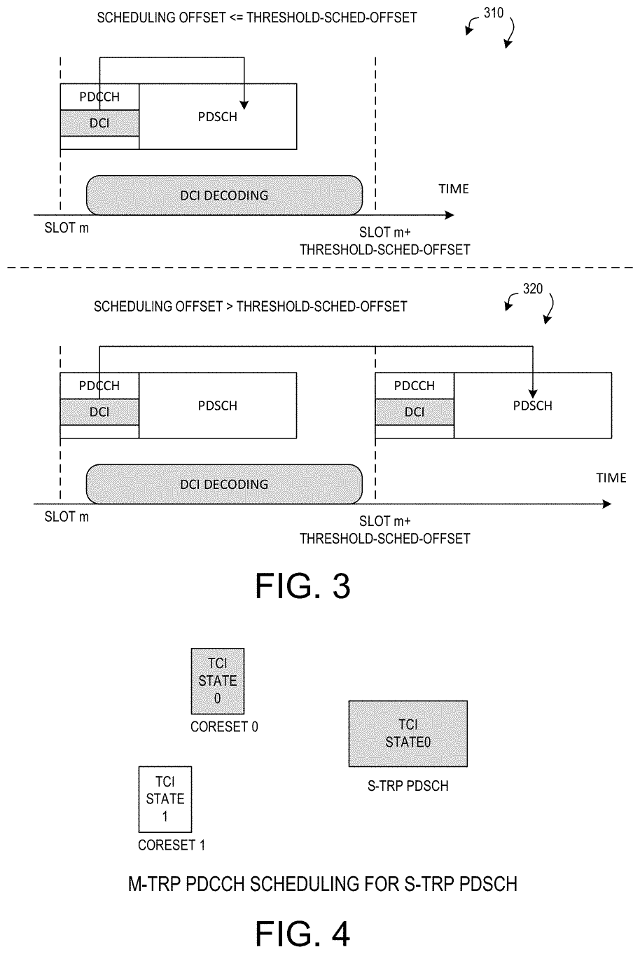

FIG. 3 illustrates PDCCH scheduling offset and corresponding TCI state determination or QCL assumption for PDSCH transmission and reception. Depending on a PDCCH scheduling offset (the time period from the PDCCH and the scheduled PDSCH) and a time duration for QCL (the time period for decoding DCI and obtain QCL info), different TCI state and QCL assumption may apply. When the scheduling offset is smaller or equal to the time duration for QCL, as depicted in 310 of FIG. 3, there is not enough time for UE to obtain QCL information from the DL DCI. Therefore, for both cases when TCI-PresentInDCI is enabled and disabled, QCL of PDSCH follows the TCI state used for PDCCH of the lowest CORESET-ID in the latest slot in which one or more CORESETs are configured within the active BWP of the serving cell.

On the other hand, when scheduling offset is greater than the time duration for QCL, as depicted in 320 of FIG. 3, QCL of PDSCH can be configured to follow a “TCI field” in the DL DCI. If TCI-PresentInDCI is enabled for the CORESET scheduling the PDSCH, QCL of PDSCH follows the TCI state presented in the DL DCI of the PDCCH transmitted on the CORESET. If TCI-PresentInDCI is disabled for the CORESET scheduling the PDSCH or the PDSCH is scheduled by a DCI format 1_0, UE assumes that the TCI state for the PDSCH is identical with the TCI state applied for the CORESET used for the PDCCH transmission. In one novel aspect, new rules of TCI state mapping and QCL assumption are defined for PDSCH when there are two CORESETS with two corresponding TCI states under M-TRP scheme with PDCCH repetition scheduling.

FIG. 4 illustrates a first embodiment of TCI state determination or QCL assumption under M-TRP PDCCH scheduling for S-TRP PDSCH. In the embodiment of FIG. 4, a UE receives PDCCH repetition scheduling under M-TRP scheme, e.g., PDCCH 0 from TRP #0 and PDCCH 1 from TRP #1, for scheduling a single PDSCH transmission occasion. TCI state 0 is used for PDCCH 0 over CORESET 0, and TCI state 1 is used for PDCCH 1 over CORESET 1. The TCI state or QCL assumption of a CORESET with lower ID (e.g., CORESET 0) is used for S-TRP PDSCH, when TCI-PresentInDCI is disabled for the CORESET scheduling the PDSCH or the PDSCH is scheduled by a DCI format 1_0.

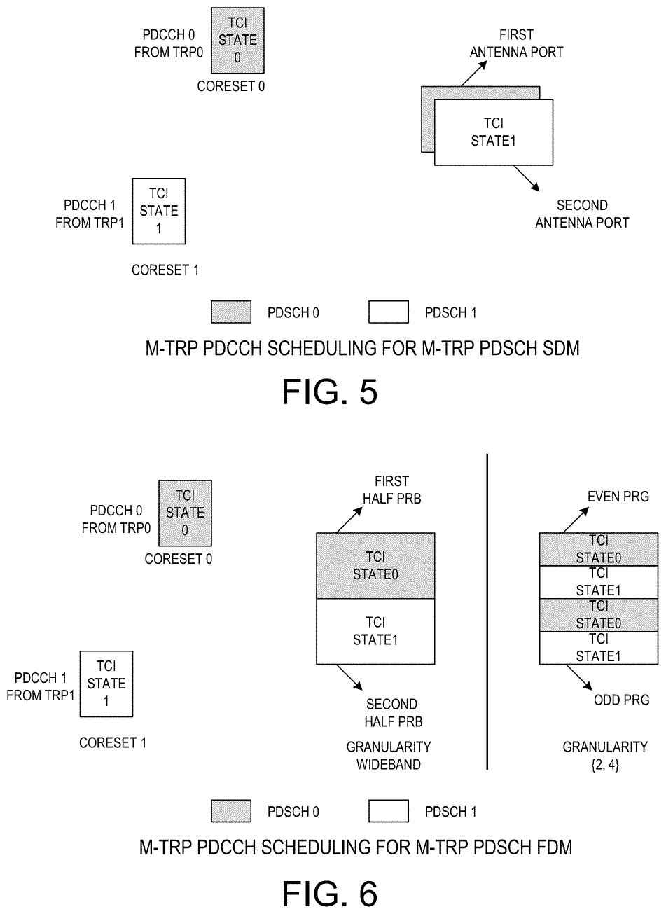

FIG. 5 illustrates a second embodiment of TCI state determination or QCL assumption under M-TRP PDCCH scheduling for M-TRP PDSCH in SDM. In the embodiment of FIG. 5, a UE receives PDCCH repetition scheduling under M-TRP scheme, e.g., PDCCH 0 from TRP #0 for scheduling a first PDSCH transmission occasion 0 from TRP #0, and receives PDCCH 1 from TRP #1 for scheduling a second PDSCH transmission occasion 1 from TRP #1. TCI state 0 is used for PDCCH 0 over CORESET 0, and TCI state 1 is used for PDCCH 1 over CORESET 1. The two PDSCH transmission occasions are associated with two TCI states and transmitted in SDM, e.g., using different CDM (code division multiplexing) groups of different antenna ports. For the TCI states or QCL assumptions for the DM-RS port(s) within two CDM groups, the TCI state or the QCL assumption of a CORESET with lower ID corresponds to the CDM group of the first antenna port indicated by the antenna port indication table; and the TCI state or the QCL assumption of a CORESET with higher ID corresponds to the other CDM group, when TCI-PresentInDCI is disabled for the CORESET scheduling the PDSCH or the PDSCH is scheduled by a DCI format 1_0.

FIG. 6 illustrates a third embodiment of TCI state determination or QCL assumption under M-TRP PDCCH scheduling for M-TRP PDSCH in FDM. In the embodiment of FIG. 6, a UE receives PDCCH repetition scheduling under M-TRP scheme, e.g., PDCCH 0 from TRP #0 for scheduling a first PDSCH transmission occasion 0 from TRP #0, and receives PDCCH 1 from TRP #1 for scheduling a second PDSCH transmission occasion 1 from TRP #1. TCI state 0 is used for PDCCH 0 over CORESET 0, and TCI state 1 is used for PDCCH 1 over CORESET 1. The two PDSCH transmission occasions are associated with two TCI states and transmitted in FDM, e.g., over different PRBs along frequency domain. For M-TRP PDCCH repetition scheduling M-TRP PDSCH which is associated with two TCI states in FDM when TCI-PresentInDCI is disabled for the CORESET scheduling the PDSCH or the PDSCH is scheduled by a DCI format 1_0, the TCI states and QCL assumption for PDSCH are determined as follows.

In one example, if precoding granularity is ‘wideband’, e.g., the entire bandwidth, then the first ┌n_PRB/2┐ PRBs are assigned to the TCI state or the QCL assumption of a CORESET with lower ID, and the remaining └n_PRB/2┘ PRBs are assigned to the TCI state or the QCL assumption of a CORESET with higher ID, where n_PRB is the total number of allocated PRBs for the UE. In another example, if precoding granularity is determined as one of the values among {2, 4}, then even precoding resource groups (PRGs) within the allocated frequency domain resources are assigned to the TCI state or the QCL assumption of a CORESET with lower ID, and odd PRGs within the allocated frequency domain resources are assigned to the TCI state or the QCL assumption of a CORESET with higher ID. Note that for each PRG, all PRBs in one PRG are be precoded with the same precoding matrix. If the precoding granularity is either 2 or 4, then it means that the actual number of consecutive PRBs in each PRG can be either 2 or 4.

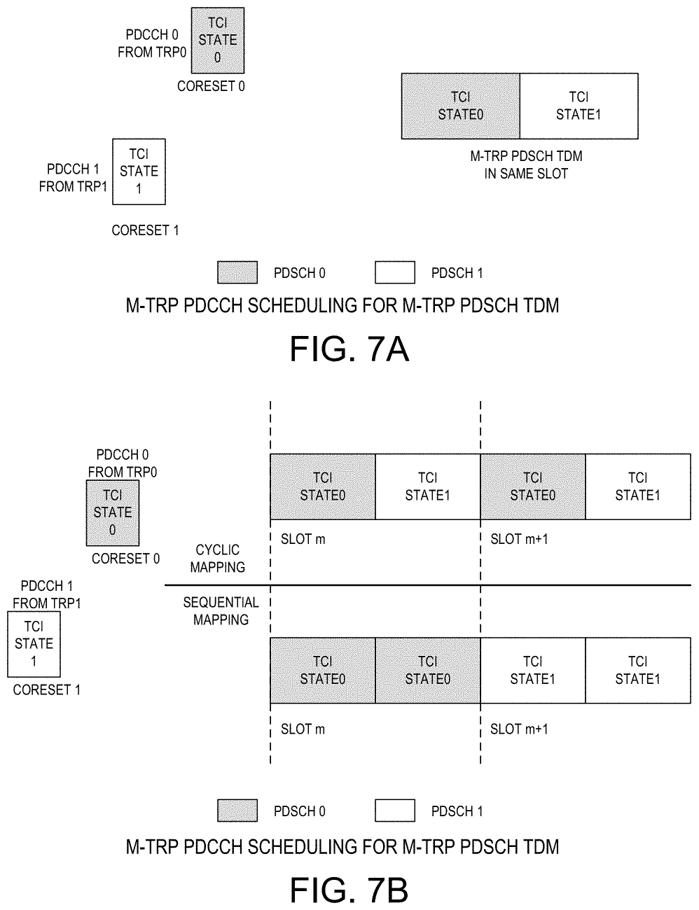

FIGS. 7A and 7B illustrate a fourth embodiment of TCI state determination or QCL assumption under M-TRP PDCCH scheduling for M-TRP PDSCH in TDM, either in the same slot, or across slots. In the embodiment of FIGS. 7A and 7B, a UE receives PDCCH repetition scheduling under M-TRP scheme, e.g., PDCCH 0 from TRP #0 for scheduling a first PDSCH transmission occasion 0 from TRP #0, and receives PDCCH 1 from TRP #1 for scheduling a second PDSCH transmission occasion 1 from TRP #1. TCI state 0 is used for PDCCH 0 over CORESET 0, and TCI state 1 is used for PDCCH 1 over CORESET 1. The two PDSCH transmission occasions are associated with two TCI states and transmitted in TDM, e.g., over different OFDM symbols in the same slot, or across different slots.

For M-TRP PDCCH repetition scheduling M-TRP PDSCH which is associated with two TCI states in TDM in a slot when TCI-PresentInDCI is disabled for the CORESET scheduling the PDSCH or the PDSCH is scheduled by a DCI format 1_0, the TCI state or the QCL assumption of a CORESET with lower (or higher) ID is applied to the first PDSCH transmission occasion and resource allocation in time domain for the first PDSCH transmission occasion. The TCI state or the QCL assumption of a CORESET with higher (or lower) ID is applied to the second PDSCH transmission occasion.

For M-TRP PDCCH repetition scheduling M-TRP PDSCH which is associated with two TCI states in TDM across slots when TCI-PresentInDCI is disabled for the CORESET scheduling the PDSCH or the PDSCH is scheduled by a DCI format 1_0, the TCI states and QCL assumption for PDSCH are determined as follows. In this case, the multi-TRP PDSCH repetition has 4 repetition of PDSCH transmission occasions. That is, one PDSCH consists of 4 PDSCH transmission occasions/repetitions. Cyclic mapping or Sequential mapping determines the order of each TRP for corresponding PDSCH repetition.

When CycMapping is enabled, TRPS are mapped alternatively, as depicted in upper part of FIG. 7B (0,1,0,1). The TCI state or the QCL assumption of a CORESET with lower (or higher) ID and the TCI state or the QCL assumption of a CORESET with higher (or lower) ID are applied to the first and second PDSCH transmission occasions, respectively, and the same TCI mapping pattern continues to the remaining PDSCH transmission occasions. When SeqMapping is enabled, TRPS are mapped alternatively, as depicted in lower part of FIG. 7B (0,0,1,1). The TCI state or the QCL assumption of a CORESET with lower (or higher) ID is applied to the first and second PDSCH transmission occasions, and the TCI state or the QCL assumption of a CORESET with higher (or lower) ID is applied to the third and fourth PDSCH transmission occasions, and the same TCI mapping pattern continues to the remaining PDSCH transmission occasions.

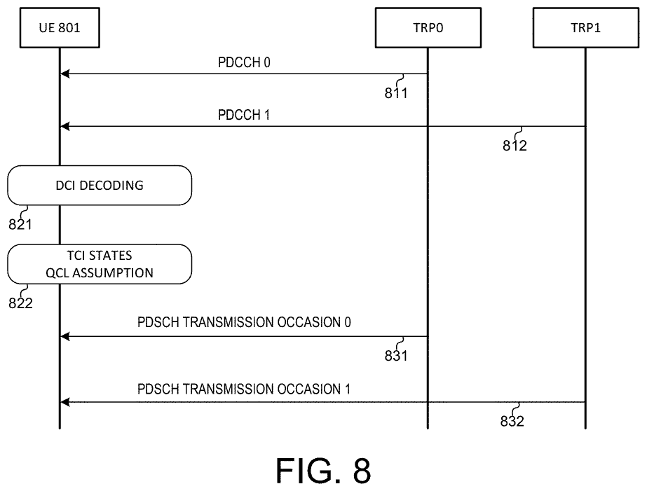

FIG. 8 is a message sequence flow between a UE and two TRPS for M-TRP PDCCH scheduling and corresponding TCI state mapping for PDSCH. In step 811, UE 801 receives a first PDCCH 0 from TRP0, scheduling for a first PDSCH transmission occasion 0. In step 812, UE 801 receives a second PDCCH 1 from TRP1, scheduling for a second PDSCH transmission occasion 1. PDCCH0 carries a first DCI over CORESET 0, and PDCCH1 carries a second DCI over CORESET 1. The TCI-PresentInDCI is disabled for the CORESET scheduling the PDSCH or the PDSCH is scheduled by a DCI format 1_0. In step 821, UE 801 performs DCI decoding. In step 822, UE 801 determines TCI states or QCL assumption for PDSCH transmission occasions, as illustrated earlier with respect to FIGS. 4-7. In step 831, UE 801 receives the first PDSCH transmission occasion 0 from TRP0, using a first determined TCI state. In step 832, UE 801 receives the second PDSCH transmission occasion 1 from TRP1, using a second determined TCI state.

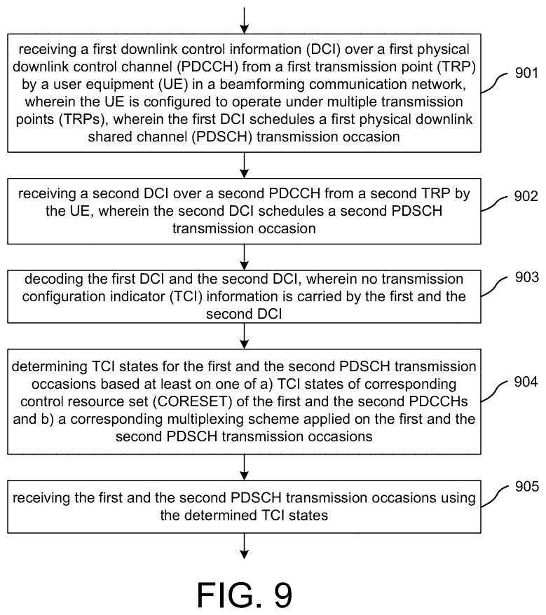

FIG. 9 is a flow chart of a method of TCI state mapping for PDSCH under M-TRP scheme with PDCCH repetition scheduling in accordance with one novel aspect. In step 901, a UE receives a first downlink control information (DCI) over a first physical downlink control channel (PDCCH) from a first transmission point (TRP) in a beamforming communication network. The UE is configured to operate under multiple transmission points (TRPs). The first DCI schedules a first physical downlink shared channel (PDSCH) transmission occasion. In step 902, the UE receives a second DCI over a second PDCCH from a second TRP. The second DCI schedules a second PDSCH transmission occasion. In step 903, the UE decodes the first DCI and the second DCI. The first and the second DCI does not carry any transmission configuration indicator (TCI) for the PDSCH transmission occasions. In step 904, the UE determines TCI states for the PDSCH transmission occasions based on at least on one of a) TCI states of corresponding to control resource set (CORESET) of the first and the second PDCCHs and b) a corresponding multiplexing scheme applied on the first and the second PDSCH transmission occasions. In step 905, the UE receives the first and the second PDSCH transmission occasions using the determined TCI states.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a first downlink control information (DCI) over a first physical downlink control channel (PDCCH) from a first transmission point (TRP) by a user equipment (UE) in a beamforming communication network, wherein the UE is configured to operate under multiple transmission points (TRPs), wherein the first DCI schedules a first physical downlink shared channel (PDSCH) transmission occasion;
receiving a second DCI over a second PDCCH from a second TRP by the UE, wherein the second DCI schedules a second PDSCH transmission occasion;
decoding the first DCI and the second DCI, wherein the first and the second DCI does not carry any transmission configuration indicator (TCI) for the PDSCH transmission occasions;
determining TCI states for the PDSCH transmission occasions based on at least one of (a) TCI states of corresponding to control resource set (CORESET) of the first and the second PDCCHs and (b) a corresponding multiplexing scheme applied on the first and the second PDSCH transmission occasions; and
receiving the first and the second PDSCH transmission occasions using the determined TCI states.

2. The method of claim 1, wherein the first DCI and the second DCI indicate same allocation information for the PDSCH transmission occasions.

3. The method of claim 1, wherein the first and the second PDSCH transmission occasions correspond to redundancy versions of a transport block (TB) transmitted from the first and the second TRP.

4. The method of claim 1, wherein TCI-PresentInDCI is disabled or DCI format 1_0 is used for the CORESETs scheduling the PDSCH transmission occasions.

5. The method of claim 1, wherein a spatial division multiplexing (SDM) scheme is applied, wherein the TCI state of the CORESET having a lower ID is applied for the PDSCH transmission occasion associated with a first antenna port, and wherein the TCI state of the CORESET having a higher ID is applied for the PDSCH transmission occasion associated with a second antenna port.

6. The method of claim 1, wherein a frequency division multiplexing (FDM) scheme is applied, wherein the TCI state of the CORESET having a lower ID is applied for the PDSCH transmission occasion associated with a first half of physical resource blocks (PRBs) in frequency domain, and wherein the TCI state of the CORESET having a higher ID is applied for the PDSCH transmission occasion associated with a second half of PRBs in frequency domain.

7. The method of claim 1, wherein a frequency division multiplexing (FDM) scheme is applied, wherein the TCI state of the CORESET having a lower ID is applied for the PDSCH transmission occasion associated with even precoding resource groups (PRGs), and wherein the TCI state of the CORESET having a higher ID is applied for the PDSCH transmission occasion associated with odd PRGs.

8. The method of claim 1, wherein a time division multiplexing (TDM) scheme is applied, wherein the TCI state of the CORESET having a lower ID is applied for the PDSCH transmission occasion having a first resource allocation of a slot in time domain, and wherein the TCI state of the CORESET having a higher ID is applied for the PDSCH transmission occasion having a second resource allocation of the same slot in time domain.

9. The method of claim 1, wherein a time division multiplexing (TDM) scheme is applied across slots, wherein the TCI state of the CORESET having a lower ID is applied for the first PDSCH transmission occasion from the first TRP, and wherein the TCI state of the CORESET having a higher ID is applied for the second PDSCH transmission occasion from the second TRP.

10. The method of claim 1, wherein a time division multiplexing (TDM) scheme is applied across slots, wherein the TCI state of the CORESET having a lower ID is applied for the first and the second PDSCH transmission occasions, and wherein the TCI state of the CORESET having a higher ID is applied for the third and fourth PDSCH transmission occasions.

11. A User Equipment (UE) comprising:
a receiver that receives a first downlink control information (DCI) over a first physical downlink control channel (PDCCH) from a first transmission point (TRP) in a beamforming communication network, wherein the UE is configured to operate under multiple transmission points (TRPs), wherein the first DCI schedules a first physical downlink shared channel (PDSCH) transmission occasion;
the receiver that receives a second DCI over a second PDCCH from a second TRP by the UE, wherein the second DCI schedules a second PDSCH transmission occasion;
a decoder that decodes the first DCI and the second DCI, wherein the first and the second DCI does not carry any transmission configuration indicator (TCI) for the PDSCH transmission occasions; and
a controller that determines TCI states for the PDSCH transmission occasions based at least on one of a) TCI states of corresponding to control resource set (CORESET) of the first and the second PDCCHs and b) a corresponding multiplexing scheme applied on the first and the second PDSCH transmission occasions, wherein the UE receives the first and the second PDSCH transmission occasions using the determined TCI states.

12. The UE of claim 11, wherein the first DCI and the second DCI indicate same allocation information for the PDSCH transmission occasions.

13. The UE of claim 11, wherein the first and the second PDSCH transmission occasions correspond to redundancy versions of a transport block (TB) transmitted from the first and the second TRP.

14. The UE of claim 11, wherein TCI-PresentInDCI is disabled or DCI format 1_0 is used for the CORESETs scheduling the PDSCH transmission occasions.

15. The UE of claim 11, wherein a spatial division multiplexing (SDM) scheme is applied, wherein the TCI state of the CORESET having a lower ID is applied for the PDSCH transmission occasion associated with a first antenna port, and wherein the TCI state of the CORESET having a higher ID is applied for the PDSCH transmission occasion associated with a second antenna port.

16. The UE of claim 11, wherein a frequency division multiplexing (FDM) scheme is applied, wherein the TCI state of the CORESET having a lower ID is applied for the PDSCH transmission occasion associated with a first half of physical resource blocks (PRBs) in frequency domain, and wherein the TCI state of the CORESET having a higher ID is applied for the PDSCH transmission occasion associated with a second half of PRBs in frequency domain.

17. The UE of claim 11, wherein a frequency division multiplexing (FDM) scheme is applied, wherein the TCI state of the CORESET having a lower ID is applied for the PDSCH transmission occasion associated with even precoding resource groups (PRGs), and wherein the TCI state of the CORESET having a higher ID is applied for the PDSCH transmission occasion associated with odd PRGs.

18. The UE of claim 11, wherein a time division multiplexing (TDM) scheme is applied, wherein the TCI state of the CORESET having a lower ID is applied for the PDSCH transmission occasion having a first resource allocation of a slot in time domain, and wherein the TCI state of the CORESET having a higher ID is applied for the PDSCH transmission occasion having a second resource allocation of the same slot in time domain.

19. The UE of claim 11, wherein a time division multiplexing (TDM) scheme is applied across slots, wherein the TCI state of the CORESET having a lower ID is applied for the first PDSCH transmission occasion from the first TRP, and wherein the TCI state of the CORESET having a higher ID is applied for the second PDSCH transmission occasion from the second TRP.

20. The UE of claim 11, wherein a time division multiplexing (TDM) scheme is applied across slots, wherein the TCI state of the CORESET having a lower ID is applied for the first and the second PDSCH transmission occasions, and wherein the TCI state of the CORESET having a higher ID is applied for the third and fourth PDSCH transmission occasions.
